(19) United States
(12) Patent Application Publication
(10) Pub. No.: US 2005/0211732 A1
(43) Pub. Date: Sep. 29, 2005

(54) Viscous liquid dispenser

(76) Inventor: Ralph George Cable, Sydney (AU)

Correspondence Address: Ralf Cable, 3 Platt Lane, Rye, NY, 10580, US

(21) Appl. No.: 10/510,203

(22) PCT Filed: Apr. 15, 2002
(86) PCT No.: PCT/AU02/00476

§ 371 Date: Oct. 1, 2004

(30) Foreign Application Priority Data
Apr. 17, 2001 (AU) PR 4434

(51) Int. Cl. G01F 11/06

(52) U.S. Cl. 222/327

(57) ABSTRACT

There is disclosed a plastics assembly for a viscous liquid dispenser (1). The plastic assembly includes an outer cover disc (41) mated with a thin inner nozzle disc (42) wherein the cover disc (41) is dimensioned to be retained at a first end of a cylindrical tube of viscous liquid to seal the tube prior to dispensing commencing, cover disc (41) having a frangible cover (42) formed thereon. The thin inner nozzle disc (42) includes an outer rim dimensioned to be received in the interior of the cover disc (41) and the thin nozzle (42) disc includes at least one nozzle aperture formed therein wherein the nozzle aperture is covered by the frangible cover (46).

### FIELD OF THE INVENTION

The present invention relates to viscous liquid dispensers and, in particular, to a dispenser used to dispense food sauces at fast food restaurants such as McDONALDS or KFC.

### BACKGROUND OF THE INVENTION

The prior art food dispenser has found widespread commercial application in such fast food outlets and consists of a spiral wound cardboard tube which has a metal annulus seamed onto the tube at one end (the dispensing end) and a forcing disc or plunger at the second end. The metal annulus has a MYLAR sheet glued to the metal annulus and the sheet is provided with at least one nozzle formed by two intersecting cuts. In order to seal the nozzle, and thereby seal the tube prior to dispensing, a metal foil is releasably glued to the front of the mylar sheet. The plunger is moved towards the nozzle when the tube is located in a dispensing gun so as to extrude the viscous contents of the tube through the nozzle(s).

The abovementioned arrangement is relatively expensive to fabricate because of the provision of metal parts. In addition, the metal foil has been found to be difficult to remove whilst the operator is wearing plastic gloves which are now a requirement in food serving industries.

### OBJECT OF THE INVENTION

The aim of the present invention is to provide a nozzle assembly and/or a forcing disc which are made from plastics material and thus are significantly cheaper than the abovementioned metal parts.

### SUMMARY OF THE INVENTION

In accordance with a first aspect of the present invention there is disclosed a plastics assembly for a viscous liquid dispenser, said assembly comprising an outer cover disc mated with a thin inner nozzle disc, said cover disc being dimensioned to be retained at a first end of a cylindrical tube of said viscous liquid to seal said tube prior to dispensing commencing and having a frangible cover formed therein, said nozzle disc having an outer rim dimensioned to be received in the interior of said cover disc, and said thin nozzle disc having at least one nozzle aperture formed therein, said nozzle aperture being covered by said frangible cover.

In accordance with a second aspect of the present invention there is disclosed a plastics forcing disc for a viscous liquid dispenser, said disc having a substantially cylindrical side wall with an annular end flange thereon to abut against the cylindrical wall of a liquid containing tube having first and second ends, whereby prior to dispensing commencing said disc covers and seals said second tube end, said end flange being provided with a plurality of spaced apart locations of weakness whereby a sufficient axial force applied to said forcing disc distorts said end flange sufficiently for said forcing disc to travel down the interior of said tube towards said first end thereof.

In accordance with a third aspect of the present invention there is disclosed a viscous liquid dispenser comprising a tube having a first and second ends and having the abovementioned nozzle assembly sealing the first end and the abovementioned forcing disc sealing the second end.

In accordance with a fourth aspect of the present invention there is disclosed, in combination, the above viscous liquid dispenser when mounted in a dispensing gun having a pushing plate which bears against the forcing disc.

### DESCRIPTION OF THE FIGURES

A preferred embodiment of the present invention will now be described, by way of example only, with reference to the drawings in which:

FIG. 1 is a schematic perspective view of a dispensing gun of the prior art,

FIG. 2 is a schematic perspective view of the prior art dispenser,

FIG. 3 is an interior plan view of the plastics forcing disc of the preferred embodiment,

FIG. 4 is a transverse cross-sectional view taken along the line IV-IV of FIG. 3,

FIG. 5 is an enlarged fragmentary view of a portion of FIG. 4,

FIG. 6 is an interior perspective view of the forcing disc of FIGS. 3-5,

FIG. 7 is a side elevation of the forcing disc of FIGS. 3-6,

FIG. 8 is an exterior plan view of the forcing disc of FIGS. 3-7,

FIG. 9 is a fragmentary enlargement of a portion of the disc illustrated in FIG. 8,

FIG. 10 is a fragmentary enlargement of a portion of the forcing disc illustrated in FIG. 7,

FIG. 11 is an exterior perspective view of the forcing disc,

FIG. 12 is a perspective view of the nozzle cover disc able to be inserted into the first end of the dispensing tube,

FIG. 13 is a plan view of the cover disc of FIG. 12,

FIG. 14 is a cross-sectional view taken along the line XIV-XIV of FIG. 13 of FIG. 12,

FIG. 15 is a fragmentary enlargement of a portion of FIG. 14,

FIG. 16 is another fragmentary enlargement of a portion of FIG. 14,

FIG. 17 is an interior perspective view of the nozzle cover disc,

FIG. 18 is an interior plan view of the nozzle cover disc,

FIG. 19 is a side elevation of the cover disc,

FIG. 20 is a fragmentary enlargement of FIG. 19,

FIG. 21 is a perspective view of the inner nozzle disc,

FIG. 22 is a plan view of the nozzle disc of FIG. 21,

FIG. 23 is a cross-sectional view taken along the line XXIII-XXIII of FIG. 22,

FIG. 24 is an enlarged fragmentary view of the rim of the nozzle disc of FIGS. 21-23, and

FIG. 25 is an enlarged view of the centre portion of the nozzle disc.

### DETAILED DESCRIPTION OF THE PREFERRED EMBODIMENT

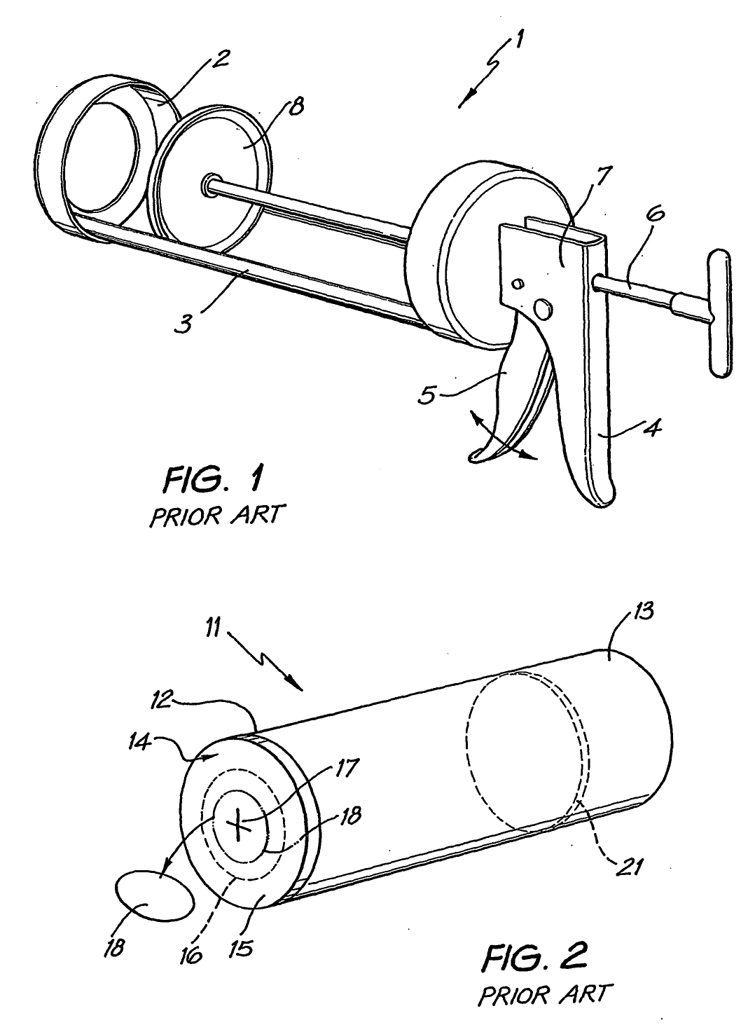

As seen in FIG. 1, a dispensing gun 1 has a tube receiving barrel 2 mounted on a frame 3. A pistol grip 4 and trigger 5 enable a plunger 6 to be moved by a ratchet mechanism 7 towards the barrel 2. The plunger 6 carries a pushing plate 8 at one end.

The dispensing gun 1 of FIG. 1 is utilized with a refill tube 11 illustrated in FIG. 2 which has a first (nozzle) end 12 and a second (plunger) end 13. The nozzle end 12 of the tube 11 is sealed by a nozzle cap 14 which consists essentially of a metal annulus 15 which is swaged or crimped to the nozzle end 12. Glued to the interior of the metal annulus 15 is a circular sheet 16 of MYLAR which is provided with a cruciform cut 17 which functions as a nozzle. In order to seal the nozzle prior to dispensing, a circular tab 18 of metal foil is adhered to the exterior of the sheet 16 over the cut 17. As indicated in FIG. 2 the circular tab is removable so as to open the cut 17 and thereby permit the food sauce contained with the tube 11 to be dispensed.

This dispensing action is carried out by pushing a plunger disc 21 along the tube axis. The plunger disc 21 is installed in the tube 11 after the tube has been filled with the sauce or other viscous liquid. The plunger disc 21 is made from plastic and metal and is pushed along the tube by the pushing plate 8 of the dispensing gun 1.

In accordance with a preferred embodiment of the present invention, both the nozzle cap 14 and the plunger disc 21 have equivalents manufactured from plastics material. These components are therefore substantially cheaper than the prior art nozzle cap 14 and plunger disc 21.

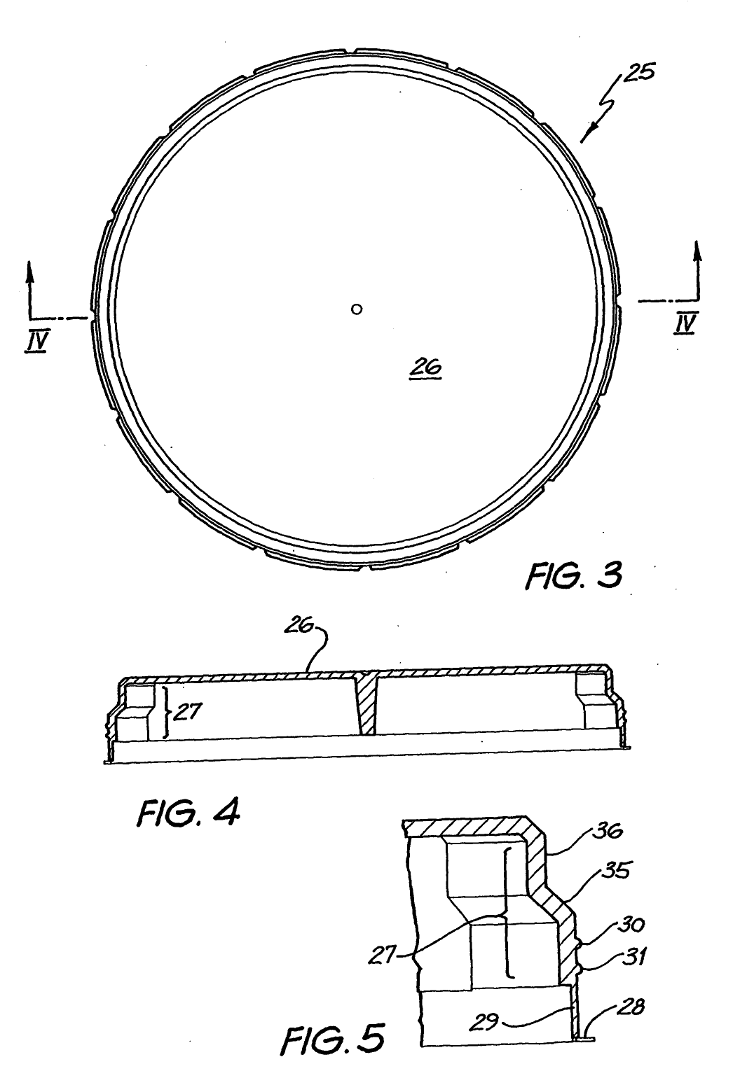

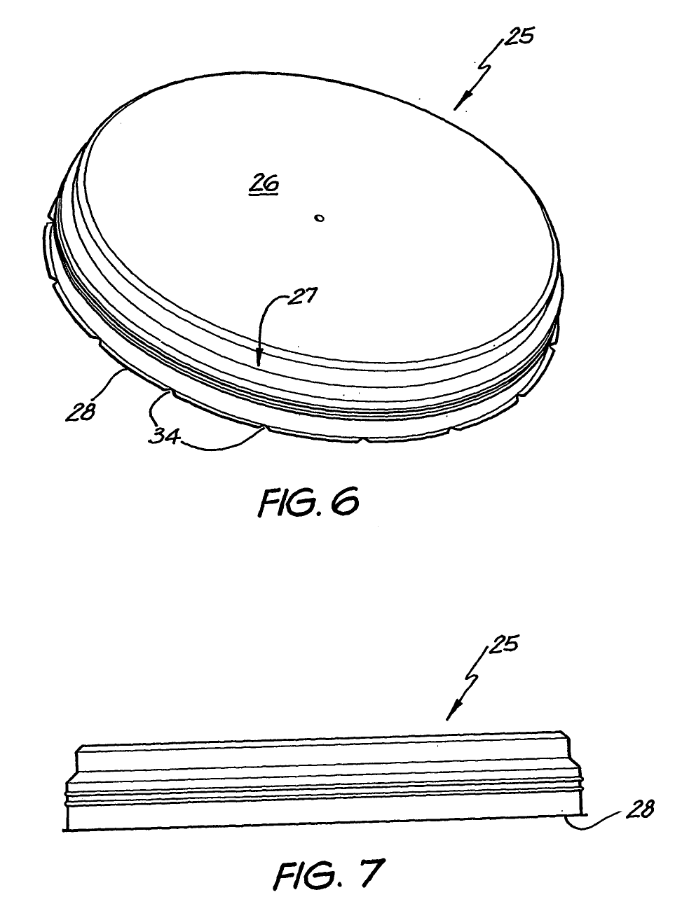

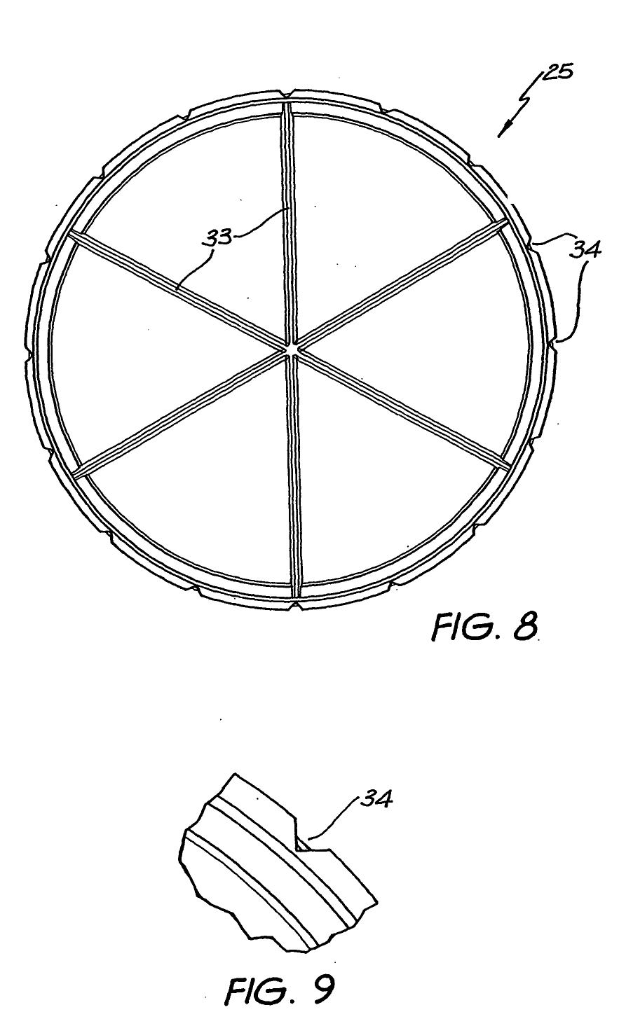

Turning now to FIGS. 3 to 11, a plastics forcing disc 25, which takes the place of the plastic and metallic plunger disc 21, is illustrated. The forcing disc 25 is circular having a smooth flat base 26 and a stepped generally cylindrical side wall 27. The side wall 27 is provided with an end flange 28 which mates with the plunger end 13 of the tube 11 and seals same prior to dispensing. The end flange 28 is supported by a thin portion 29 of the side wall 27. The side wall 27 is also provided with a pair of annular sealing beads 30, 31 which seal the forcing disc 25 against the interior of the tube 11.

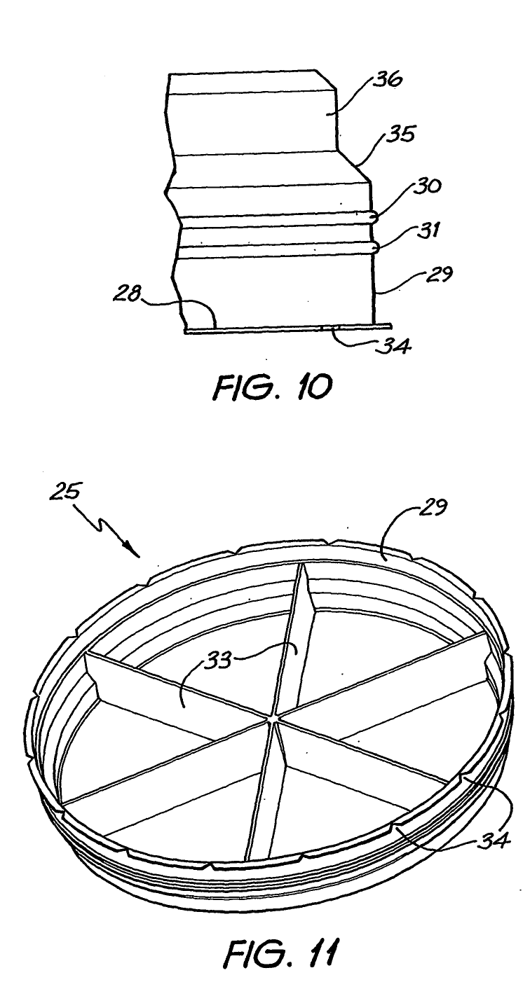

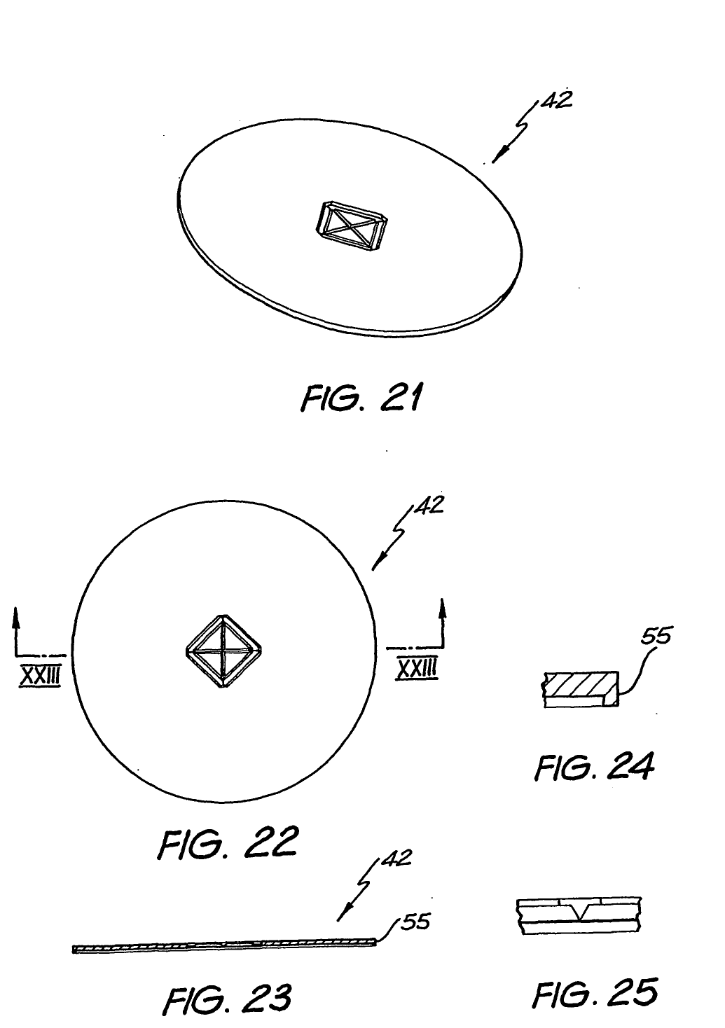

As best seen in FIG. 11, the forcing disc 25 is provided with six stiffening ribs 33 which extend from the centre of the forcing disc 25 radially outwardly and merge with the side wall 27 but do not engage the thin portion 29. As best seen in FIGS. 8 and 11, the end flange 28 is provided with a multiplicity of notches 34 which are intended to deliberately weaken the end flange 28. As best seen in FIG. 10 the side wall 27 is stepped at 35 to provide a boss 36 of slightly reduced diameter which mates with the nozzle disc illustrated in FIGS. 21-25.

It will be appreciated that after the plunger 11 has been filled with viscous liquid, the forcing disc 25 is placed into the plunger end 13 of the tube 11. The sealing beads 30, 31 and the end flange 28 in combination seal the tube 11 and maintain the plunger ends 13 sealed until such time as dispensing is required.

When dispensing is required, the tube 11 is placed in the gun 1 and the pushing plate 8 is brought to bear on the stiffening ribs 33. The axial force of the pushing plate 8 is sufficient to urge the forcing disc 25 towards the nozzle end 12 of the tube 11. This is accomplished by the notches 34 allowing the end flange 28 to buckle inwardly. This is assisted by the thin section of the thin portion 29 thereby permitting the end flange 28 to buckle and slide within the interior of the tube 11.

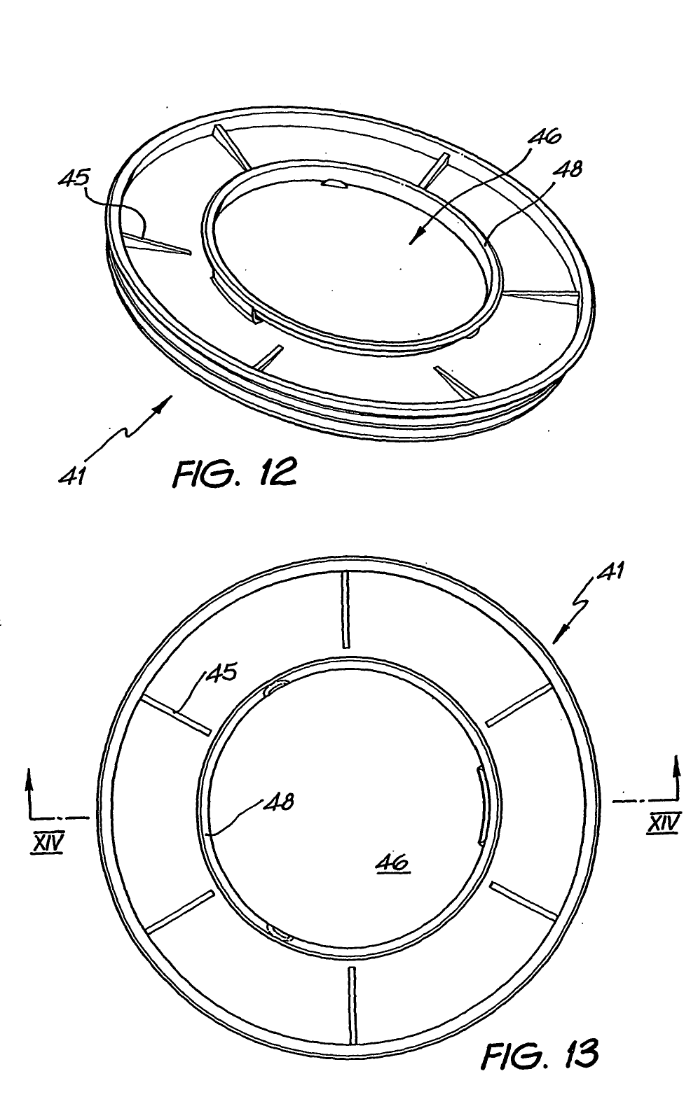

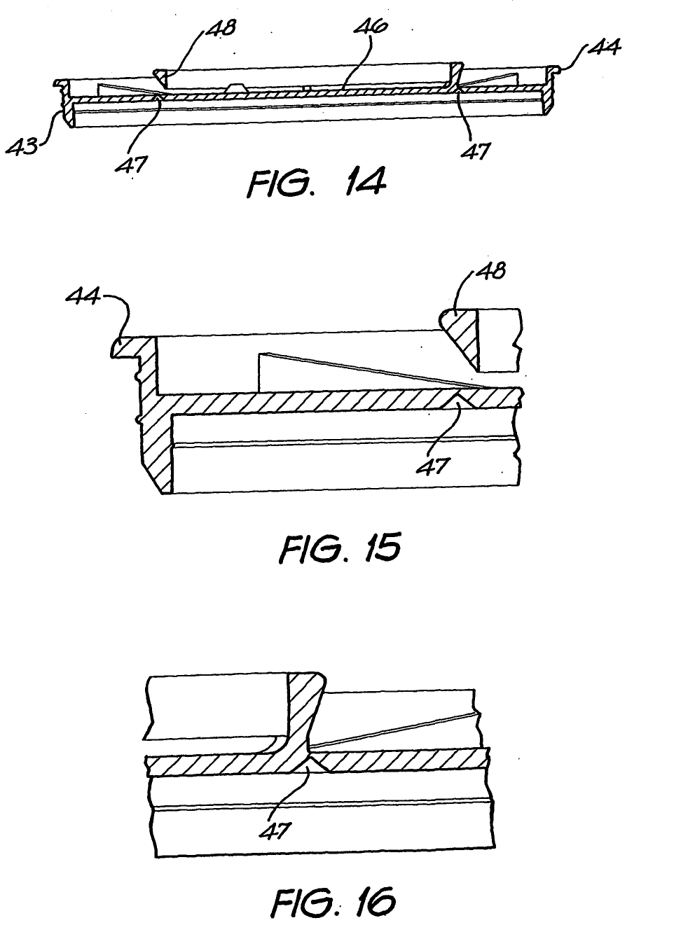

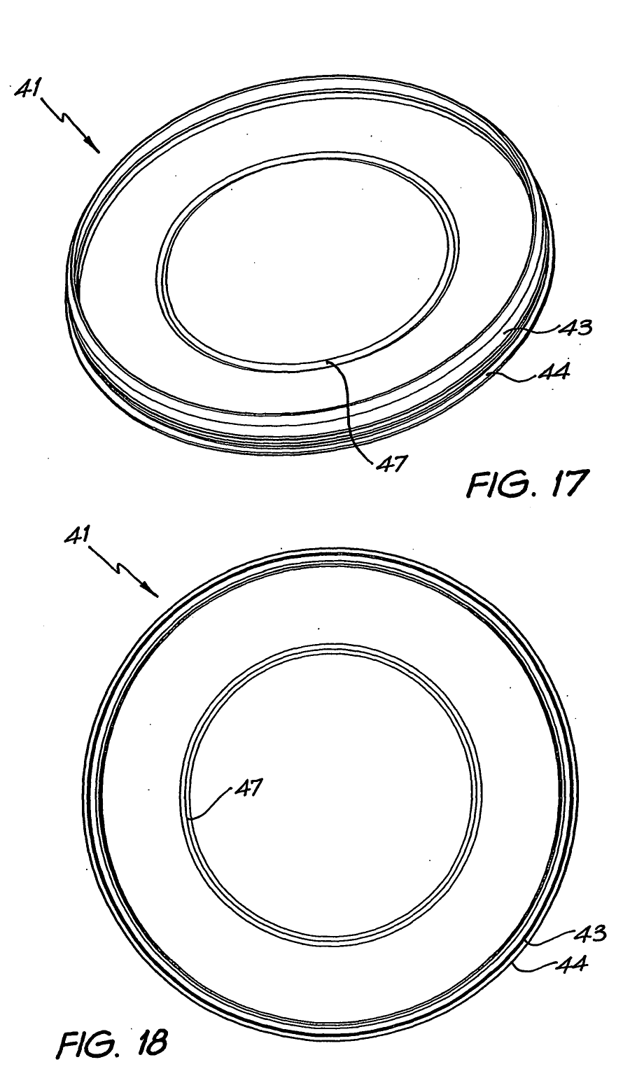

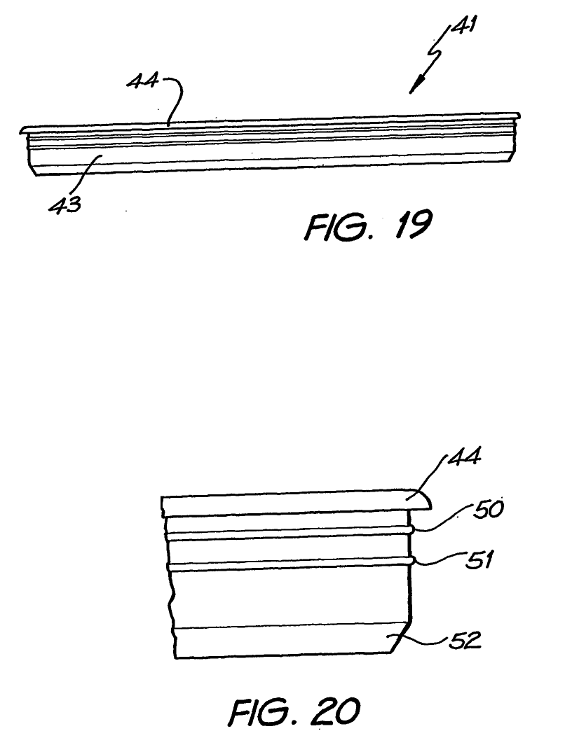

Tuning now to FIGS. 12-25, the prior art nozzle cap 14 is replaced by a nozzle assembly made up from an outer cover disc 41 (FIGS. 12-20) and an inner nozzle disc 42 (FIGS. 21-25). The cover disc 41 has a side wall 43 which is preferably glued to the interior of the tube 11 with an annular end flange 44 abutting the nozzle end 12 of the tube 11. Radial stiffening ribs 45 extend between the side wall 43 and a circular, centrally located, frangible portion 46 defined by a circular groove 47. The frangible portion 46 is provided with a hinged circular finger grip 48. The finger grip 48 is able to be grasped by a finger of a user and pulled thereby rupturing the circular groove 47 and permitting the frangible portion 46 to be detached from the remainder of the cover disc 41.

As best seen in FIG. 20, the side wall 43 is provided with sealing beads 50, 51 and a tapered leading edge 52 which assists in insertion of the nozzle assembly into the nozzle end 12 of the tube 11. The tapered leading edge 52 is also preferably longitudinally slotted (not illustrated) which enables the leading edge 52 to be compressed during the insertion procedure. If there is insufficient compression of the tube 11 by the sealing beads 50, 51, then the cover disc 41 can be glued to the interior of the tube 11.

Turning now to the nozzle disc 42, this is provided with a side wall 55 which is dimensioned to mate with the interior of the side wall 43 of the cover disc 41. As best seen in FIG. 23, the nozzle disc 42 is very thin and has one or more cruciform cuts created during moulding, so as to form the nozzle or nozzles of the dispenser.

The nozzle disc 42 fits snuggly within the interior of the cover disc 41 and as so assembled replaces the prior art nozzle cap 14. The frangible portion 46 ensures that the cruciform cut(s) in the disc 42 are sealed until such time as dispensing is required. Furthermore, the profile of the nozzle disc 42 and the forcing disc 25 are essentially the same so that the forcing disc 25 and, in particular, the boss 36 thereof fits snuggly within the nozzle disc 42 when the forcing disc 25 is pushed fully into the tube 11. In this way an absolute minimum of the dispensed viscous liquid is left remaining in the dispenser when dispensing is finally completed.

The foregoing describes only one embodiment of the present invention and modifications, of this to those skilled in the art, can be made thereto without departing from the scope of the present invention.

The term “comprising” as used herein is used in the inclusive sense of “having” or “including” and not in the exclusive sense of “consisting only of”.

1. A plastics assembly for a viscous liquid dispenser, said assembly comprising an outer cover disc mated with a thin inner nozzle disc, said cover disc being dimensioned to be retained at a first end of a cylindrical tube of said viscous liquid to seal said tube prior to dispensing commencing and having a frangible cover formed therein, said nozzle disc having an outer rim dimensioned to be received in the interior of said cover disc, and said thin nozzle disc having at least one nozzle aperture formed therein, said nozzle aperture being covered by said frangible cover.

2. The assembly according to claim 1 wherein said nozzle disc is dimensioned to closely receive a forcing disc whereby a small abutment gap is formed between said nozzle disc and said forcing disc when said forcing disc is pushed towards said nozzle disc to thereby leave a minimum of said viscous liquid in said dispenser.

3. The assembly according to claim 1 or 2 wherein said cover disc is provided with a substantially cylindrical side wall having at least one annular bead, and an annular end flange which protrudes beyond said side wall.

4. The assembly according to claim 3 wherein said side wall tapers away from said end flange.

5. The assembly according to any one of claims 1 to 4 wherein said frangible cover is provided with a finger engagement means to permit said cover to be pulled from said cover disc and thereby expose said at least one nozzle aperture.

6. A plastics forcing disc for a viscous liquid dispenser, said disc having a substantially cylindrical side wall with an annular end flange thereon to abut against the cylindrical wall of a liquid containing tube having first and second ends, whereby prior to dispensing commencing said disc covers and seals said second tube end, said end flange being provided with a plurality of spaced apart locations of weakness whereby a sufficient axial force applied to said forcing disc distorts said end flange sufficiently for said forcing disc to travel down the interior of said tube towards said first end thereof.

7. The forcing disc according to claim 6 wherein said side wall thereof is stepped having a forward portion of smaller diameter dimensioned to pass into the side wall of the abovementioned nozzle disc.

8. The forcing disc according to claim 6 or 7 and including a plurality of stiffening ribs.

9. The forcing disc according to claim 8 wherein said ribs are radially arranged and have a uniform depth whereby a pushing plate of a dispensing gun can bear against said ribs.

10. The forcing disc according to claim 9 wherein said ribs extend along said side wall but not so far as said end flange thereof.

11. A viscous liquid dispenser comprising a tube having first and second ends and having said nozzle assembly as defined in any one of claims 1 to 5 sealing said first end and said forcing disc as defined in any one of claims 6 to 10 sealing said second end.

12. In combination, said viscous liquid dispenser as defined in paragraph 11 when mounted in a dispensing gun having a pushing plate which bears against said forcing disc.
